(19) United States
(12) Patent Application Publication
(10) Pub. No.: US 2002/0095334 A1
(43) Pub. Date: Jul. 18, 2002

(54) Method and system of posting electronic poster through public network

(76) Inventor: Tze Chung Kao, Irvine, CA (US)

Correspondence Address: Raymond Yat Chiu Chan, 1050 Oakdale Lane, Acradia, CA, 91006, US

(21) Appl. No.: 09/764,945

(22) Filed: Jan. 17, 2001

(51) Int. Cl. G06F 17/60

(52) U.S. Cl. 705/14

(57) ABSTRACT

A method and system of posting electronic poster through public network accepts posting orders from advertisers by regional service centers, wherein each of the regional service centers obtains information of where and when is each of said electronic posters available for whatever posting size from the central control system through the public network. The posting order will be sent to a central control system display in each of the electronic posters designated by the respective advertiser in the designated size and time by the respective regional control center while each of the electronic posters is always remained electronically controlled by the respective regional control center.

### BACKGROUND OF THE PRESENT INVENTION

1. Field of Invention

The present invention relates to advertisement or message billboards and posters, and more particularly to a method and system of posting electronic poster through public network, which allows one to control and post an advertisement and/or message in different designated languages at anytime in one or more designated electronic posters in different location in the world through a public network while being cost effectively.

2. Description of Related Arts

Various advertising channels for goods promotion are available nowadays. Manufacturers and retailers advert their goods through a mass media such as television or radio, or a press media such as newspaper. Another alternative kinds of advertising channel are the billboard and the poster. The billboard is generally constructed on a huge steel made support frame along the freeway or on the wall of a building. The poster is generally posted on an eye watching location, such as a wall of a restaurant, a panel of a bus stop, or corridors of a shopping mall, for easily attracting people's attention.

The billboard is large enough to attract everybody's sight but it can't replace the advertisement printing too often because it is too costly, such as a big screen in Time Square's billboard or Las Vegas. Therefore, the owner of the billboard charges very high rental fee and such expensive monthly fee is merely charged to the same single advertiser. Even though some billboard and big screen poster system are arranged to be capable of switching one advertisement to another automatically in order to lower the time expense for the advertisers, the initial settings and the maintenance of the big screen cannot be simplified and cost effective. Thus, such billboard or big screen poster system cannot deliver real time information and feedback instantly to the advertiser.

Posting a poster on the eye-catching location is still considered to be one of the best advertisements since people can view the poster everyday while they are walking on street or driving back and forth from home to office. Such advertising poster is formed in either a static display such as a printed material or a dynamic display wherein the poster is projected by a projecting device.

However, a frame for posting the poster thereon has a restricted size according to different locations, such that in order to fit all size of the frames, the poster must be printed in various sizes, which is costly. Thus, the same poster is normally posted for certain days. After the promotion period, the used posters are generally thrown away, which is a waste of resource. Also, the transportation of the posters to different designated locations is a great hassle, especially the relatively larger size of the printed poster that cannot be folded and need to be taken good care.

The major drawback of the conventional poster is that the eye-catching locations for posting the poster are expensive. Also, such poster location must be rented per day, week or even month. Therefore, it will be very expensive to post a poster in a public area event though the target customers may only appear within a relative short period of time, such as half an hour, per day.

Moreover, since most of the products are deliver and sell throughout the world, the advertising cost for posting posters all over the world is extremely expensive because of the various versions and languages are required fro printing different posters. It is not economic for company to produce thousands of posters in different languages and sent them out to countries all around the world.

For example, as shown in FIG. 1, the advertiser must individually contact each advertising agent in each location all over the world. Each advertising agent must convert the poster into the home language and then print out the poster with various sizes for fitting into the respective poster frame. So, the process from contacting the advertising agent to the placing the post may take months, or even half a year. In other words, the advertiser must plan at least three months before the poster is placed. Thus, if any updated information or change of the poster, the advertiser may merely ignore them since a little bit of correction may take another month to re-set and re-print the entire poster, which is a waste of time and resource.

Practically, even though the target customers will only show up at a particular advertising area at a specific time period in each day, every advertiser still has to pay the rent of posting his or her poster at that particular advertising area for that entire day. For example, if the advertisement is about a new “toy”, the target customers are the schoolboys and schoolgirls who may only appear at a particular advertising area near the bus stop or train station near the school. Obviously, the effective time period for advertising the “toy” should be around the morning period before the school time and the afternoon period after the school time. The advertiser will not interest at the time period, such as the evening and the midnight time period, when there would have no student or parent passing by. However, the “toy” advertiser is mandated to rent the whole day for the same advertisement content. However, to some advertisers, such as the nightclubs or alcoholic products, they are not interested to post advertisement during the school time at the bus stops or train station. But they may like to post advertisement at the nighttime because most of their target customers will show up at the nighttime. In fact, it is quite unreasonable that although the adequate advertisement spaces and areas are very limited and expensive, the advertisers have to pay for the time periods when they basically do not want to post advertisement. Most of the advertisers have limited budgets for advertisement and to use the limited budget to post advertisement at the wrong time for the wrong people is not effective and uneconomic and is absolutely a waste of resource.

### SUMMARY OF THE PRESENT INVENTION

A main object of the present invention is to provide a method and system of posting electronic poster through public network, so that the advertiser can select specific period of time within each day to post a particular size of advertisement at one or more predetermined advertising areas all over the world for every advertising service or product. In other words, the advertiser may maximize the advertising effect within a limited advertisement budget. According to the present invention, no money and resource will be waste for posting wrong advertisement at the wrong time in the wrong place for the wrong customers.

Another object of the present invention is to provide a method and system of posting electronic poster through public network, wherein the electronic poster is capable of serving as a video, such as real time information, such that the electronic poster can be more dazzling and informative so as to attract people's attention.

Another object of the present invention is to provide a method and system of posting electronic poster through public network, wherein the electronic poster is remote controlled and monitored through the electronic network.

Another object of the present invention is to provide a method and system of posting electronic poster through public network, wherein the electronic poster is adjustably fit for any size of the display device such that no limited size of the electronic poster is restricted.

Another object of the present invention is to provide a method and system of posting electronic poster through public network, which comprises a monitor device including a video camera or “WebCam” for incorporating with the electronic poster for monitoring the electronic poster in live time manner and sending back a feedback and/or posting stage instantly to a central control system, so that both the central control system and the corresponding advertisers can monitor the real condition and performance of the advertisements. Moreover the monitor device can also record the response of the target customers, including whether the target customers will be attracted by the advertisement or how the target customers react with the advertisement, and such recorded response will be fed back to the central control system and the corresponding advertisers.

Accordingly, in order to accomplish the above objects, the present invention is to provide a method of posting electronic poster through public network, which comprises the steps of:

(a) providing a plurality of regional service centers and regional control centers in a plurality of regional territories and a central control system networked with the regional service and control centers through a public network system;

(b) providing at least an electronic poster in each of the regional territories, which is maintained and controlled by the respective regional control center;

(c) accepting posting orders from advertisers by the regional service centers, wherein each of the regional service centers obtains information of where and when is each of said electronic posters available for whatever posting size from the central control system through the public network;

(d) sending each of the posting orders to the central control system from the respective regional service center, wherein each of the posting orders includes posting information of posting content, time and size for one or more of the electronic posters designated by the respective advertiser;

(e) affirming the posting orders by the central control system by confirming posting schedules of each of the posting orders with one or more of the regional control centers that in charge of the electronic posters designated by the respective advertiser;

(f) recording a poster content for each of the posting orders by the central control system and sending the recorded poster content to the regional control centers in charge of the electronic posters designated by the respective advertiser;

(g) booking and confirming advertising time with one or more of the regional control centers 22 controlling the electronic posters 10 designated by the respective advertiser 50 by the central control system 30; and

(h) displaying the recorded poster content in each of the electronic posters designated by the respective advertiser in the designated size and time by the respective regional control center while each of the electronic posters is always remained electronically controlled by the respective regional control center.

### BRIEF DESCRIPTION OF THE DRAWINGS

FIG. 1 is a block diagram illustrating a conventional advertising channel.

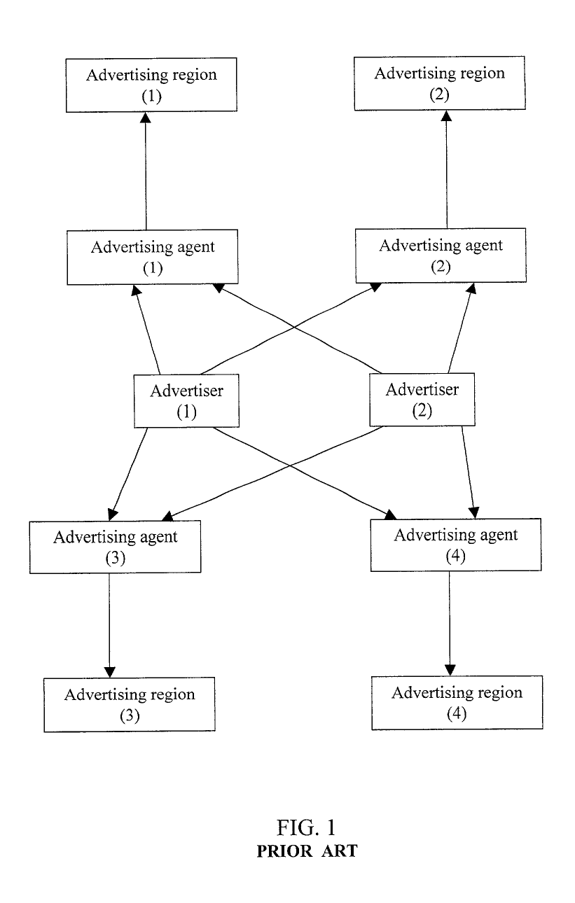

FIG. 2 is a block diagram illustrating a system of posting electronic poster through public network according to a preferred embodiment of the present invention.

FIG. 3 is a flow chart of the method of posting electronic poster through public network according to the above preferred embodiment of the present invention.

### DETAILED DESCRIPTION OF THE PREFERRED EMBODIMENT

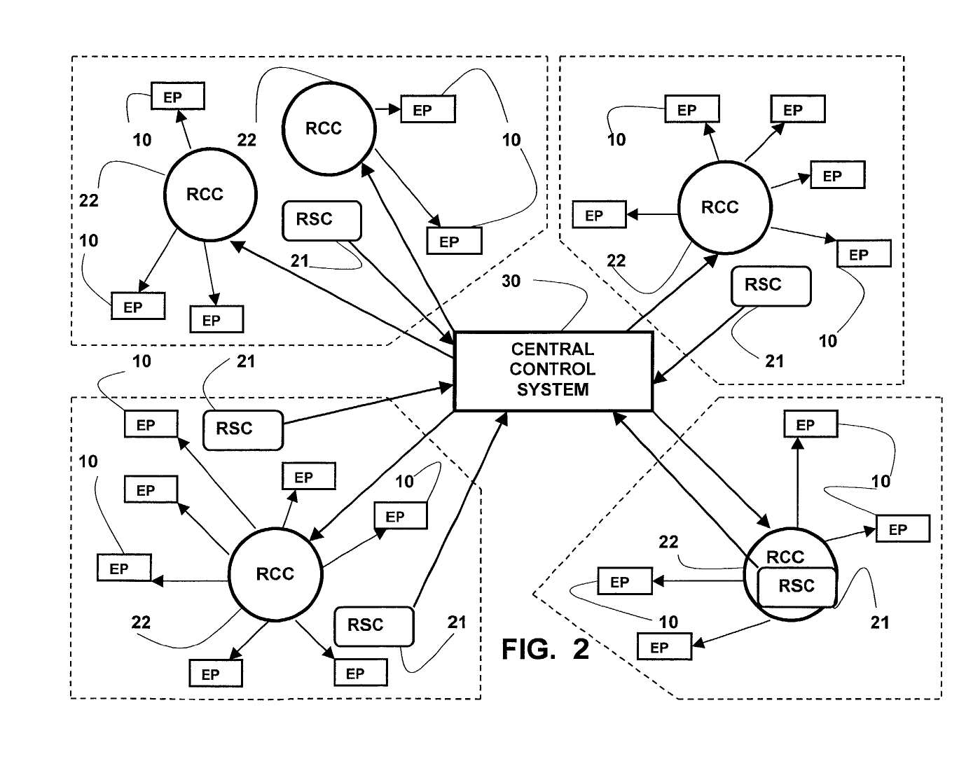

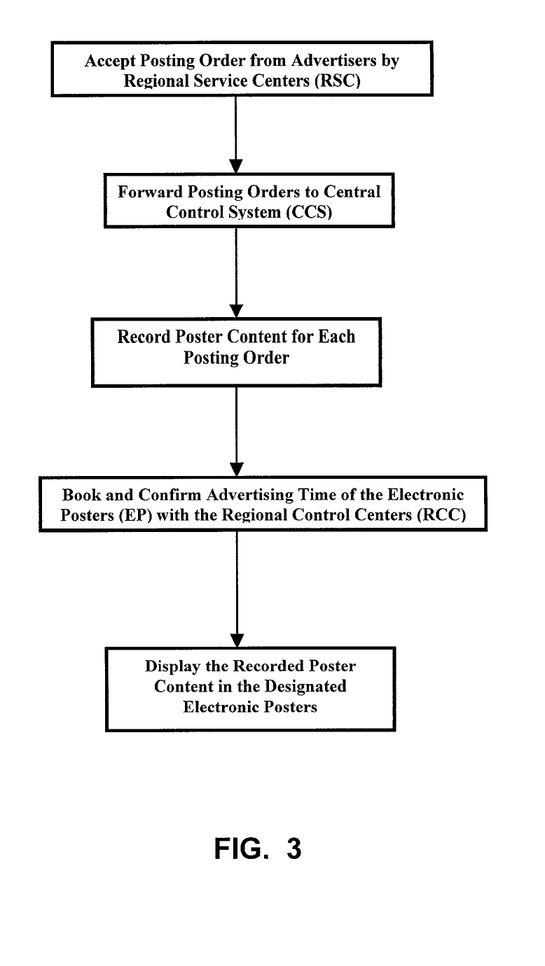

Referring to FIGS. 2 and 3 of the drawings, a method and system of posting electronic poster through public network according to a preferred embodiment of the present invention is illustrated. The method of posting electronic poster through public network generally comprises the following steps.

Step (1) Provide a plurality of regional service centers 21 and regional control centers 22 in a plurality of regional territories 1 and a central control system 30 networked with the regional service and control centers 21, 22 through a public network 40.

Step (2) Provide at least an electronic poster 10 in each of the regional territories 1, which is maintained and controlled by the respective regional control center 22.

Step (3) Accept posting orders from advertisers 50 by the regional service centers 21, wherein each of the regional service centers 21 obtains information of where and when is each of said electronic posters 10 available for whatever posting size from the central control system 30 through the public network 40.

Step (4) Send each of the posting orders to the central control system 30 from the respective regional service center 21, wherein each of the posting orders includes posting information of posting content, time and size for one or more of the electronic posters 10 designated by the respective advertiser 50.

Step (5) Affirm the posting orders by the central control system 30 by confirming posting schedules of each of the posting orders with one or more of the regional control centers 22 that in charge of the electronic posters 10 designated by the respective advertiser 50.

Step (6) Record a poster content for each of the posting orders by the central control system 30 and sending the recorded poster content to the regional control centers 22 in charge of the electronic posters 10 designated by the respective advertiser 50.

Step (7) Book and confirm advertising time with one or more of the regional control centers 22 controlling the electronic posters 10 designated by the respective advertiser 50 by the central control system 30.

Step (8) Display the recorded poster content in each of the electronic poster 10 designated by the respective advertiser 50 in the designated size and time by the respective regional control center 22 while each of the electronic posters 10 is always remained electronically controlled by the respective regional control center 22.

In the step (1), the central control system 10 is owned and managed by a headquarter corporation. The central control system 10 should equipped with at least a powerful advertisement engine which is a super computer for operating all the posting orders and recording all the posting content of each posting order. The regional service centers 21 and regional control centers 22 should be located at one or more designated places anywhere in the world, especially the big cities.

The regional service and control centers 21, 22, which can be directly owned and managed by a headquarters or be contracted with headquarters, each equips with an operation computer. To the regional service centers 21, their computers are networked together through the central control system 30.

To the regional control centers 22, their computers are preferably graphic computers downwardly with the same graphic design software so that each of the regional control centers 22 is capable of designing the posting content for each posting order within their controlling zone respectively.

In other words, each regional service center 21 serves the advertisers 50 resided in the corresponding regional territory 1 and accepting posting orders from the advertisers 50 to post advertisements in this and all other regional territories 1. Therefore, the advertisers have no need to contact so many billboard owners of poster agencies all over the world. Each advertiser 50 just needs to contact his or her local regional service center 21 personally or through Internet. Then, the advertiser 50 can obtain information and posting schedules all over the world. Each advertiser 50 can also make posting order and pay at the local regional service center 21 with native language. So that even a Chinese advertiser who does not know any English still can place posting order to his or her local regional service center 21 and communicate with Chinese. A large amount of communication time and cost is saved. The efficiency is much increased accordingly.

Each of the regional control centers 22 of a corresponding regional territory 1, which is networked with the central control system 30, is responsible for the maintenance and management of all the electronic posters 10 within that regional territory 1. Therefore, the regional control center 22 knows better about the native language and domestic habit of the residents in its regional territory 1. Therefore, the regional control centers 22 know better what kinds of people would show up at every electronic poster 10 located in their own regional territories 1. And, the regional control centers are also in a better position of controlling the posting schedules of the electronic posters 10 within that regional territory 1. Each of the regional control centers 22 should provide a suggested schedule and reference for different categories of services and products to post their advertisements in different time period a day in every electronic poster 10 within its regional territory 1 in order to obtain a better advertisement effect. Each of the regional control centers 22 must well maintain the electronic posters 10 within their regional territories 1 to function normally.

In the step (2), the electronic poster 10 can be different size and serve different language at the same time. All of the designated electronic posters 10 can be linked together as required by the advertiser 50. The electronic poster 10 is a display device that can be a flat screen LCD PC monitor, a projection television, a projector operated by computer, a LCD television, and etc.

In the step (3), the advertisers 50 can provide their own poster designs to the regional service centers 21 while placing posting orders. If so, the advertisers 50 may also appoint the regional control centers 22 of the designated regional territories 1 to translate their poster deigns into the native languages for them before displaying in the electronic poster 10.

In the step (3), alternatively, the advertisers 50 may also hire the regional control centers 22 in their designated regional territories to design the posting contents in native languages for them. It will be especially practical when smaller piece of advertisement is required by the advertiser 50.

Each regional service center 22 can be contracted with or owned by the headquarter corporation wherein each regional service center 20 functions as an individual advertising agent which can provide a local service and link to another regional service center 21 or regional control center 22 through the central control system 30 for providing an international service. The regional service centers 21 and the regional control centers 22 should have full electronic and computer technical such as consultant and technical adviser in order to provide customer service and to design the electronic poster 10 respectively for assisting the advertisers 50.

The regional territories 1 of the regional service centers 21 may not be the same of the regional control centers 22. That is there may be more than one regional control centers 22 in a particular regional territory 1 while it may contain only one regional service center 21. Moreover, within a regional territory 1, the regional service center 21 and the regional control center 22 can be owned and operated by a single company contracted with the headquarter corporation.

In order to facilitate the process of placing posting order, each of the electronic posters 10 is assigned with poster code, so that when placing a poster order, the advertiser 50 can specifically order to place advertisement in the electronic posters 10 with the corresponding poster codes. Each of the regional service center 21 and regional control center 22 may also assigned with a service code and a control code respectively, so that in each posting order, it will clearly indicate which regional service center 21 does the posting order come from and which regional control centers 22 will handle the advertisements. Both the regional service centers 21 and the regional control centers 22 can exactly contact to the other party in communicate with the posting information and matter in related to the respective advertisers 50.

In the step (4), when each of the regional service centers 21 sends in a posting order to the central control system 30 for its advertiser 50, the posting order must include a posting code per each order, wherein each posting code contains the poster code representing the designated electronic poster 10, the service code representing the regional service center 21 that send out that posting order, and, if necessary, the control code representing the designated regional control center 22 that handles the posting order.

The posting order can also be sent directly by the advertisers 50 who personally visit at the regional service center 21 with the assistance of the consultant or technical adviser in that regional service center 21.

Moreover, detail information of the poster content to be posted in the designated electronic poster 10, such as selected language and time-posting schedule, should also be included in each of the posting orders. Of course, each of the regional service centers 21 should provide an informative service such as survey or research that is adapted for guiding the advertisers 50 to elect the most effective electronic posters 10 in the right locations to place their posting orders. For example, the regional service center 21 will guide the advertiser 50 who is a notebook manufacturer to place his or her advertisements at the electronic posters 10 located in the business area during the business hours so as to attract the maximum number of business people.

In the step (5), the posting order must be sent to the central control system 30 first for confirmation so as to ensure there is no conflict, such as time conflict, with another posting order that has been sent from another regional service center 21. The central control system 30 is preferred managed by the headquarter corporation in such a manner that the final decision would be made by the central control system 30.

In the step (6), no matter the poster content is designed by the advertiser 50 or the regional control center 22, the poster content is downloaded in the advertisement engine of the central control system 30. The poster content can be permanently saved in the advertisement engine until the corresponding advertiser 50 requests to delete the record.

In the step (7), according to each of the posting orders from the regional service centers 21, the central control system 30 will immediately contact the corresponding regional control centers 22 which are in charge of the designated electronic posters 10 ordered by the advertiser 50 to book the designated advertising time of the designated electronic posters 10. The central control system 30 will receive a confirmation from the corresponding regional control centers 22. Then, the central control system 30 will download the poster contents of the posting orders to the corresponding regional control centers 22.

If a speedy and powerful public network, such as the DSL of Internet, is used, the electronic posters 10 can be directly controlled by the central control system 30, where the electronic posters 10 are 24 hours connected with the central control system 30 through the public network, so that the central control system 30 can download and switch the posting content of each of the electronic poster 10 from time to time.

After the scheduling of the electronic posters 10 by the central control system 30, the posting orders is sent to the corresponding regional control center 22 with respect to the posting codes included in the posting orders.

In the step (8), the electronic posters 10 within the regional territory 1 of the corresponding regional service center 22 will be arranged to display the recorded poster content. The size of the poster content will also be re-arranged to fit the displaying size of the electronic poster 10. It is worth to mention that since more than one poster contents can be posted on the electronic poster 10 at the same time.

Since the poster content is written by computerized format, the regional control center 22 is adapted for setting the electronic posters 10 easily by using the graphic computer. Thus, the electronic poster 10 is adapted for revising the poster content or updating the information anytime even during posting, so as to provide a real-time information for the electronic poster 10. For example, price of a product display on the electronic poster 10 can be updated even during the posting time by the regional control center 22 (or the central control system 30 if that electronic poster 10 is directly controlled by the central control system 30), so as to minimize an error of the information of the electronic poster 10 and speed up the posting process thereof for obtaining the best advertising result from the electronic poster 10.

In addition, the central control system 30 and/or the regional control center 22 can also responsible to modify the poster content with different languages to fit the multi-languages of the advertising regions in the world. For example, for the electronic posters 10 located in the United State, the poster content can be converted into English version, Spanish version, and Chinese version, etc in such a manner that different versions of the electronic poster 10 will be posted on different racial areas.

Accidentally, the electronic poster 10 may be corrupted. Therefore, as mentioned above, when the poster content is sent to the regional control center 22, the digital poster content is also downloaded to form a backup by the regional control center 22. So, when the electronic poster 10 accidentally corrupted, the backup of all the poster contents of the electronic poster 10 can be used to place on the electronic poster 10.

After the step (8), the present invention is preferred to include a monitoring step (9) of monitoring each of the electronic posters 10 through the public network 40, wherein a monitor device 60 which can be a video camera or “WebCam” is installed near each of the electronic posters 10 for monitoring the electronic poster 10 in live time manner and sending back a feedback and/or posting stage instantly to the regional control center 22 and the central control system 30 through the public network 40.

Therefore, both the central control system 30 and the corresponding advertisers 50 can monitor the real condition and performance of the advertisements. Moreover the monitor device 60 can also record the response of the target customers, including whether the target customers will be attracted by the advertisement or how the target customers react with the advertisement, and such recorded response will be fed back to the central control system 30 and the corresponding advertisers.

Accordingly, the system of posting electronic poster through public network comprises:

a central control system 30,

a plurality of electronic posters 10 located in various regional territories 1 all over the world;

a plurality of regional service centers 21, which are provided in the regional territories respectively, communicating with the central control system 30 via a public network 40, wherein the regional service centers accept posting orders from advertisers 50 and obtain information of where and when is each of said electronic posters 10 available for whatever posting size from the central control system 30 through the public network 40; and

a plurality of regional control centers 22, which are provided in the regional territories respectively and communicated with the central control system 30 through the public network, each maintaining and controlling the electronic posters 10 located in the respective regional territory, wherein each of the regional control centers 22 provides posting schedules of the electronic posters 10 within the regional territory 1 thereof and makes sure the designated poster contents are correctly displayed in the designated electronic posters 10 for the correct time periods respectively.

In view of above, the method and system of posting electronic poster through public network according to the present invention can substantially provide the following advantages in comparison with the conventional poster menu system:

(i) The present invention enables an advertiser in one place to directly advertise all kinds of products all over the world through the electronic public network such as Internet. Therefore, the advertiser can save his or her time spent on searching the advertising locations and agents so as to speed up the prosecution of the poster advertisement.

(ii) The regional service and control centers are provided in each city where providing a complete computer system connecting with the central control system. So, the electronic posters are remote controlled and technical supported by the central control system and the regional service and control centers, so as to provide the best service for all advertisers.

(iii) The regional control center remote controls the electronic posters through the public network so that the electronic poster can provide a real time information from the regional control center.

(iv) The electronic poster can not only provide poster image but also provide flash, video, and sound so that the electronic poster will become more dazzling, attractive, and informative.

(v) The electronic poster can be served as different languages. Once the posting order is sent to the regional control center, the electronic poster is adapted for being converted into the corresponding home language.

(vi) The size of the poster content will not be restricted anymore. The size of the poster content can be adjusted electronically to fit all kinds of electronic poster having different dimensions operated by a graphic computer.

(vii) The advertisers of the electronic posters have no need to rent the whole day of the electronic posters. The limited advertisement budget of the advertiser can be spent effectively and economically by just renting a preferred time period of a particularly during which the maximum target customers can see the poster content.

For example, for a business advertisement can merely rent those electronic posters located in bus stops or train station for the time periods such as around 9:00 am and the 5:00 pm per day as the posting time. No rental fee will be wasted to post such a business advertisement in the afternoon or during the midnight while most of the business people are staying in the offices or at homes. To the advertisers, the limited advertisement budget can be saved to post advertisement at the electronic posters located in some other time zone cities. To the electronic posters, between 9:00 am to 5:00 pm will be the preferred time period for posting house ware advertisement for those advertisers like house ware manufacturers to which the housewives are their target customers.

(viii) The entire poster screen of each of the electronic poster at a certain time period can be fully employed by one advertisement or shared with other poster contents. In other words, the advertisers may select to rent only a portion of the poster screen for a designated time, i.e. to share the advertising time with other advertisements. Of course, the advertisers can select the types of advertisement to be shared with central control system. For example, a main poster content, which occupies half of the poster screen of an electronic poster, will be posted during 8:00 am to 10:00 am. However, the other half of poster screen can be divided into two advertising space and rented to other advertisers, wherein each of the poster contents of the other advertisers will be posted for only three minutes in sequence during 8:00 am to 10:00 am.

(ix) The advertisers do not need to send employees to check and record the advertisement efficiency of all the posters posted all over the world. Instead, the advertisers can review and monitor each of the electronic posters posting their advertisement all over the world through the Internet in live time manner because each of the electronic posters is monitored by a video camera or a “WebCam”. Therefore, the advertisers can change the poster contents of different electronic posters from time to time in responsive to the actual advertisement effect achieved by every electronic poster.

What is claimed is:

1. A method of posting electronic poster through public network, comprising the steps of:
(a) providing a plurality of regional service centers and regional control centers in a plurality of regional territories and a central control system networked with said regional service and control centers through a public network;
(b) providing at least an electronic poster in each of said regional territories, which is maintained and controlled by said respective regional control center;
(c) accepting posting orders from advertisers by said regional service centers, wherein each of said regional service centers obtains information of where and when is each of said electronic posters available for whatever posting size from said central control system through said public network;
(d) sending each of said posting orders to said central control system from said respective regional service center, wherein each of said posting orders includes posting information of posting content, time and size for one or more of said electronic posters designated by said respective advertiser;
(e) recording a poster content for each of said posting orders by said central control system and sending said recorded poster content to said regional control centers in charge of said electronic posters designated by said respective advertiser;
(f) booking and confirming advertising time with one or more of said regional control centers controlling said electronic posters designated by said respective advertiser by said central control system; and
(g) displaying said recorded poster content in each of said electronic poster designated by said respective advertiser in said designated size and time by said respective regional control center while each of said electronic posters is always remained electronically controlled by said respective regional control center.

2. The method as recited in claim 1, after the step (d), further comprising a confirming step of affirming said posting orders by said central control system by confirming posting schedules of each of said posting orders with one or more of said regional control centers that in charge of said electronic posters designated by said respective advertiser.

3. The method as recited in claim 1 wherein each of said regional service and control centers equips with an operation computer and said central control system contains an advertisement engine which is a central processing computer networked with said operation computers of said regional service centers and said regional control centers through said public network.

4. The method as recited in claim 2 wherein each of said regional service and control centers equips with an operation computer and said central control system contains an advertisement engine which is a central processing computer networked with said operation computers of said regional service centers and said regional control centers through said public network.

5. The method as recited in claim 1 wherein, in the step (f) further comprising a sub-step of translating said poster content into one or more native languages.

6. The method as recited in claim 2 wherein, in the step (f), further comprising a sub-step of translating said poster content into one or more native languages.

7. The method as recited in claim 1 wherein, in the step (a), further comprises a sub-step of providing a suggested schedule and reference for different categories of services and products to post their advertisements in different time period a day in every electronic poster within said regional territory by said respective regional control center to said central control system.

8. The method as recited in claim 2 wherein, in the step (a), further comprises a sub-step of providing a suggested schedule and reference for different categories of services and products to post their advertisements in different time period a day in every electronic poster within said regional territory by said respective regional control center to said central control system.

9. The method as recited in claim 6 wherein, in the step (a), further comprises a sub-step of providing a suggested schedule and reference for different categories of services and products to post their advertisements in different time period a day in every electronic poster within said regional territory by said respective regional control center to said central control system.

10. The method as recited in claim 1 wherein each of said electronic poster is a display device.

11. The method as recited in claim 2 wherein each of said electronic poster is a display device.

12. The method as recited in claim 1 wherein said poster contents are designed and provided by said advertisers.

13. The method as recited in claim 2 wherein said poster contents are designed and provided by said advertisers.

14. The method as recited in claim 1 wherein said poster contents to be posted in one of said electronic posters are designed by said regional control center of said electronic poster.

15. The method as recited in claim 2 wherein said poster contents to be posted in one of said electronic posters are designed by said regional control center of said electronic poster.

16. The method as recited in claim 1 wherein, in the step (d), each of said posting order for each of said electronic posters is sent with a posting code which includes at least a poster code assigned to represent said electronic poster.

17. The method as recited in claim 2 wherein, in the step (d), each of said posting order for each of said electronic posters is sent with a posting code which includes at least a poster code assigned to represent said electronic poster.

18. The method as recited in claim 16 wherein each of said regional service centers and regional control centers is assigned with a service code and a control code respectively, wherein in each of said posting orders, said service code clearly indicates which of said regional service centers does said posting order and said control code indicates which of said regional control centers in charge said electronic poster.

19. The method as recited in claim 17 wherein each of said regional service centers and regional control centers is assigned with a service code and a control code respectively, wherein in each of said posting orders, said service code clearly indicates which of said regional service centers does said posting order and said control code indicates which of said regional control centers in charge said electronic poster.

20. The method as recited in claim 9 wherein, in the step (d), each of said posting order for each of said electronic posters is sent with a posting code which includes at least a poster code assigned to represent said electronic poster.

21. The method as recited in claim 20 wherein each of said regional service centers and regional control centers is assigned with a service code and a control code respectively, wherein in each of said posting orders, said service code clearly indicates which of said regional service centers does said posting order and said control code indicates which of said regional control centers in charge said electronic poster.

22. The method as recited in claim 18 wherein each of said posting orders further comprises detail information of said poster content to be posted in said designated electronic poster, including a selected language and a time-posting schedule.

23. The method as recited in claim 19 wherein each of said posting orders further comprises detail information of said poster content to be posted in said designated electronic poster, including a selected language and a time-posting schedule.

24. The method as recited in claim 21 wherein each of said posting orders further comprises detail information of said poster content to be posted in said designated electronic poster, including a selected language and a time-posting schedule.

25. The method as recited in claim 1 wherein the step (h) further comprises a step of downloading said poster contents of said posting orders to said corresponding regional control centers.

26. The method as recited in claim 2 wherein the step (h) further comprises a step of downloading said poster contents of said posting orders to said corresponding regional control centers.

27. The method as recited in claim 9 wherein the step (h) further comprises a step of downloading said poster contents of said posting orders to said corresponding regional control centers.

28. The method as recited in claim 20 wherein the step (h) further comprises a step of downloading said poster contents of said posting orders to said corresponding regional control centers.

29. The method as recited in claim 1 wherein more than one of said poster contents are allowed to arrange share a full screen of said electronic poster at the same time.

30. The method as recited in claim 2 wherein more than one of said poster contents are allowed to arrange share a full screen of said electronic poster at the same time.

31. The method as recited in claim 9 wherein more than one of said poster contents are allowed to arrange share a full screen of said electronic poster at the same time.

32. The method as recited in claim 27 wherein more than one of said poster contents are allowed to arrange share a full screen of said electronic poster at the same time.

33. The method as recited in claim 1, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

34. The method as recited in claim 2, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

35. The method as recited in claim 9, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

36. The method as recited in claim 20, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

37. The method as recited in claim 27, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

38. The method as recited in claim 32, after the step (g), further comprising a step (h) of monitoring each of said electronic posters through said public network, wherein a monitor device is installed adjacent to each of said electronic posters for monitoring said electronic poster in live time manner and sending back a feedback and posting stage instantly to said regional control center and said central control system through said public network.

39. A system of posting electronic poster through public network, comprising:
a central control system,
a plurality of electronic posters located in various regional territories 1 all over said world;
a plurality of regional service centers, which are provided in said regional territories respectively, communicating with said central control system via a public network, wherein said regional service centers accept posting orders from advertisers and obtain information of where and when is each of said electronic posters available for whatever posting size from said central control system through said public network; and
a plurality of regional control centers, which are provided in said regional territories respectively and communicated with said central control system through said public network, each maintaining and controlling said electronic posters located in said respective regional territory, wherein each of said regional control centers provides posting schedules of said electronic posters within said regional territory thereof and makes sure said designated poster contents are correctly displayed in said designated electronic posters for said correct time periods respectively.

40. The method as recited in claim 39 wherein each of said regional service and control centers equips with an operation computer and said central control system contains an advertisement engine which is a central processing computer networked with said operation computers of said regional service centers and said regional control centers through said public network.
